(19) United States
(12) Patent Application Publication
(10) Pub. No.: US 2024/0163245 A1
(43) Pub. Date: May 16, 2024

(54) NETWORK SYSTEMS, CONTROL METHODS, DATABASES, CONTROLLERS, AND PROGRAMS

(71) Applicant: NIPPON TELEGRAPH AND TELEPHONE CORPORATION, Tokyo (JP)

(72) Inventors: Tatsuya FUKUI, Musashino-shi, Tokyo (JP); Toshihito FUJIWARA, Musashino-shi, Tokyo (JP); Ryota SHIINA, Musashino-shi, Tokyo (JP); Tomohiko IKEDA, Musashino-shi, Tokyo (JP); Hiroya ONO, Musashino-shi, Tokyo (JP)

(73) Assignees: NIPPON TELEGRAPH AND TELEPHONE CORPORATION, Tokyo (JP); NIPPON TELEGRAPH AND TELEPHONE CORPORATION, Tokyo (JP)

(21) Appl. No.: 18/282,405

(22) PCT Filed: Apr. 8, 2021
(86) PCT No.: PCT/JP2021/014876

§ 371 Date: Sep. 15, 2023

(51) Int. Cl. H04L 61/00; G06F 3/14; H04L 9/40; H04L 49/35

(52) U.S. Cl. CPC H04L 61/35; G06F 3/14; H04L 49/35; H04L 63/08

(57) ABSTRACT

In order to solve the above problem, an object of the present invention is to provide a network system, a control method, a database, a controller, and a program capable of path construction in a device IF direct access network without disclosing connection information.

A network system according to the present invention (1) specifies and records a location on a network of a user and a device used by the user by using exchange of authentication data using a media signal of the device, and (2) when the user makes a connection request to content by using a user name, a controller solves location information on the network by using the user name, controls the network, and realizes connection between the content and the device.

### TECHNICAL FIELD

The present disclosure relates to a device IF direct access network and a control method thereof.

### BACKGROUND ART

With the spread of Long Term Evolution (LTE) and 5th Generation (5G), use of entertainment content using video and audio has progressed. When the entertainment content as described above is used, in a general form, a video device such as a camera or a monitor, an acoustic device such as a microphone or a speaker, and an operation device such as a mouse or a keyboard are connected to a computer, and a user selects content or constructs a network path through the computer to use the content (see FIG. 1(A)). Note that this network path construction means that the computer is assigned an IP address from the network and accesses the IP address of the server obtained from a DNS.

However, in the form of FIG. 1(A), a computer to which various devices can be connected is required. Therefore, a user who does not have a computer but has only a smartphone cannot use the content, or uses the content on a small screen of the smartphone even if the user can use the content. Thus, a form in which a video device or an audio device is connected to a media converter (MC) connected to a public network as illustrated in FIG. 1(B), and these devices and a content server are directly connected has been studied.

In the form (device IF direct access network) as illustrated in FIG. 1(B), it is necessary to realize construction of a path between a server on which content desired to be used by the user is implemented and a device used by the user without a computer. Examples of the method include a method using an HDMI (registered trademark) matrix switch as in Non Patent Literature 1. This method is a method of managing which physical device is connected to each port of the HDMI matrix switch and changing the setting of the matrix switch when the physical device to be connected is instructed. By the present method, devices without a unique ID can be connected.

### CITATION LIST

### Non Patent Literature

Non Patent Literature 1: HDMI 8×8 high vision matrix switch aHD-MTX88, (https://icsil.ocnk.net/product/897; searched on Mar. 19, 2021)

### SUMMARY OF INVENTION

### Technical Problem

However, since the MC and the network in the configuration of FIG. 1(B) are connected by a plurality of users, when connection is enabled by designating the ID and the physical port number of the MC, connection not intended by the user is also enabled. Specifically, it is possible to easily execute change of the connection designating the ID and the physical port number of the MC used by another user. That is, the method of constructing a path by the method of designating the ID and the physical port number of the MC in the configuration of FIG. 1(B) has a problem that it is difficult to prevent a connection change from another user.

Therefore, in order to solve the above problem, an object of the present invention is to provide a network system, a control method, a database, a controller, and a program capable of path construction in a device IF direct access network without disclosing connection information.

### Solution to Problem

In order to achieve the above object, a network system according to the present invention
(1) specifies and records a location on a network of a user and a device used by the user by using exchange of authentication data using a media signal of the device, and
(2) when the user makes a connection request to content by using a user name, a controller solves location information on the network by using the user name, controls the network, and realizes connection between the content and the device.

Specifically, a network system according to the present invention is a device interface direct access type network system in which a device not having a unique ID is connected via a media converter having a port having a unique ID and identifiable in a network, the network system including:
an authentication infrastructure that authenticates the device in an authentication operation of transmitting and receiving, via a user terminal, authentication data converted into a media signal between the user terminal of a user and the device by the media converter, and specifies the device used by the user from the media converter specified in the authentication operation; and
a database that registers location information in which location of the device specified in the authentication operation is associated with a user name of the user.

Further, the network system according to the present invention may include:
a controller that grasps the location of the device from the database on the basis of the user name of the user when the user makes a connection request to content in the network, and sets a path between the content and the device on the basis of the location.

In addition, a control method according to the present invention is a control method for a device interface direct access type network in which a device not having a unique ID is connected via a media converter having a port having a unique ID and identifiable in a network, the control method including:
authenticating the device in an authentication operation of transmitting and receiving, via a user terminal, authentication data converted into a media signal between the user terminal of a user and the device by the media converter, and specifying the device used by the user from the media converter specified in the authentication operation; and
registering location information in which location of the device specified in the authentication operation is associated with a user name of the user in a database.

Further, the control method according to the present invention may include:
grasping the location of the device from the database on the basis of the user name of the user when the user makes a connection request to content in the network, and setting a path between the content and the device on the basis of the location.

In addition, a database according to the present invention is a database included in a device interface direct access type network system in which a device not having a unique ID is connected via a media converter having a port having a unique ID and identifiable in a network, the database including:
when authenticating the device in an authentication operation of transmitting and receiving, via a user terminal, authentication data converted into a media signal between the user terminal of a user and the device by the media converter, and specifying the device used by the user from the media converter specified in the authentication operation, registering location information in which location of the device specified in the authentication operation is associated with a user name of the user; and
when the user makes a connection request to content in the network, notifying a controller that connects the content and the device on the basis of the location, of the location of the device based on the user name of the user.

Further, a controller according to the present invention is a controller included in a device interface direct access type network system in which a device not having a unique ID is connected via a media converter having a port having a unique ID and identifiable in a network, the controller including:
from a database that authenticates the device in an authentication operation of transmitting and receiving, via a user terminal, authentication data converted into a media signal between the user terminal of a user and the device by the media converter, and specifies the device used by the user from the media converter specified in the authentication operation, and in which location information in which location of the device specified in the authentication operation is associated with a user name of the user is registered,
grasping the location of the device on the basis of the user name of the user when the user makes a connection request to content in the network, and connecting the device to the content on the basis of the location.

Authentication data (QR code (registered trademark) or the like) using a media signal of the device is exchanged (authentication operation) via a network, the location of the device used by the user on the network is specified on the network side, and the location information of the user and the device is recorded in a database (DB). With this operation, the location of the device used by the user on the network can be grasped on the network side.

Further, when the user makes a connection request, the controller inquires of the DB about the location of the device used by the user on the network to specify the location, and sets the network (connection path) on the basis of the obtained location information. With this operation, it is possible to configure a network path via the device used by the user without disclosing information of the network to the user.

Therefore, the present invention can provide a network system, a control method, a database, and a controller capable of path construction in a device IF direct access network without disclosing connection information.

Here, as timing, when the device is connected to the media converter, the authentication infrastructure preferably performs the authentication operation, and the database preferably registers the location information of the device.

In addition, when the device is removed from the media converter, the database preferably deletes the location information of the device.

The present invention is a program for causing a computer to function as the controller. A data collection apparatus of the present invention can also be implemented by a computer and a program, and the program can be recorded in a recording medium or provided through a network.

Note that the inventions described above can be combined as much as possible.

### Advantageous Effects of Invention

The present invention can provide a network system, a control method, a database, a controller, and a program capable of path construction in a device IF direct access network without disclosing connection information.

### BRIEF DESCRIPTION OF DRAWINGS

FIG. 1 is a diagram describing a problem of the present invention.

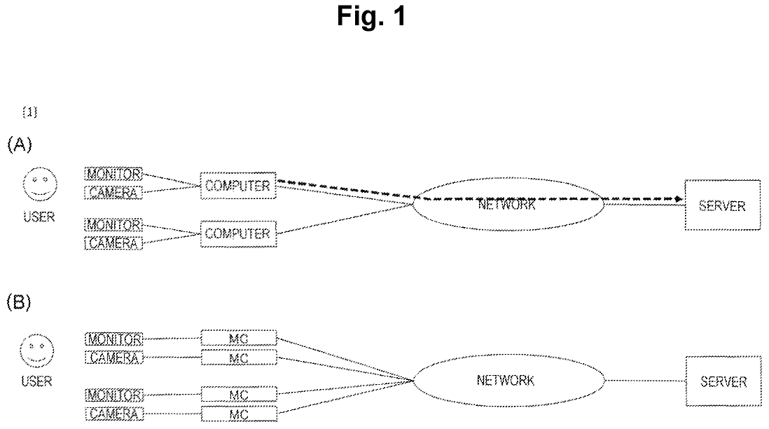

FIG. 2 is a diagram describing a network system according to the present invention.

FIG. 3 is a diagram describing a media converter included in a network system according to the present invention.

FIG. 4 is a diagram describing a media converter included in a network system according to the present invention.

FIG. 5 is a diagram describing a media converter included in a network system according to the present invention.

FIG. 6 is a diagram describing a media converter included in a network system according to the present invention.

FIG. 7 is a diagram describing a media converter included in a network system according to the present invention.

FIG. 8 is a diagram describing a media converter included in a network system according to the present invention.

FIG. 9 is a diagram describing an authentication data input/output unit included in a network system according to the present invention.

FIG. 10 is a diagram describing an authentication infrastructure included in a network system according to the present invention.

FIG. 11 is a diagram describing a network location information DB included in a network system according to the present invention.

FIG. 12 is a diagram describing a network configuration information DB included in a network system according to the present invention.

FIG. 13 is a diagram describing a network configuration information DB included in a network system according to the present invention.

FIG. 14 is a diagram describing (A) a content domain name DB and (B) a user domain name DB included in a network system according to the present invention.

FIG. 15 is a diagram describing an authentication data generation rule table included in a network system according to the present invention.

FIG. 16 is a diagram describing an authentication data input/output unit management table included in a network system according to the present invention.

FIG. 17 is a diagram describing a network location information DB dynamic configuration flow of a control method according to the present invention.

FIG. 18 is a diagram describing a user login flow of a control method according to the present invention.

FIG. 19 is a diagram describing a user DB included in a network system according to the present invention.

FIG. 20 is a diagram describing a control signal in a control method according to the present invention.

FIG. 21 is a diagram describing a control signal in a control method according to the present invention.

FIG. 22 is a diagram describing a control signal in a control method according to the present invention.

FIG. 23 is a diagram describing a control signal in a control method according to the present invention.

FIG. 24 is a diagram describing a control signal in a control method according to the present invention.

FIG. 25 is a diagram describing a control signal in a control method according to the present invention.

FIG. 26 is a diagram describing an authentication data input/output unit management table included in a network system according to the present invention.

FIG. 27 is a diagram describing an authentication data temporary storage memory included in a network system according to the present invention.

FIG. 28 is a diagram describing a control signal in a control method according to the present invention.

FIG. 29 is a diagram describing an authentication data transmission/reception unit operation state table included in a network system according to the present invention.

FIG. 30 is a diagram describing a screen of a smartphone of a user.

FIG. 31 is a diagram describing a control signal in a control method according to the present invention.

FIG. 32 is a diagram describing a control signal in a control method according to the present invention.

FIG. 33 is a diagram describing a network location information DB included in a network system according to the present invention.

FIG. 34 is a diagram describing a control signal in a control method according to the present invention.

FIG. 35 is a diagram describing a control signal in a control method according to the present invention.

FIG. 36 is a diagram describing a user belonging domain name DB included in a network system according to the present invention.

FIG. 37 is a diagram describing a control signal in a control method according to the present invention.

FIG. 38 is a diagram describing a control signal in a control method according to the present invention.

FIG. 39 is a diagram describing a control signal in a control method according to the present invention.

FIG. 40 is a diagram describing an authentication data transmission/reception unit operation state table included in a network system according to the present invention.

FIG. 41 is a diagram describing a screen of a smartphone of a user.

FIG. 42 is a diagram describing a control signal in a control method according to the present invention.

FIG. 43 is a diagram describing a control signal in a control method according to the present invention.

FIG. 44 is a diagram describing a control signal in a control method according to the present invention.

FIG. 45 is a diagram describing an authentication data temporary storage memory included in a network system according to the present invention.

FIG. 46 is a diagram describing a control signal in a control method according to the present invention.

FIG. 47 is a diagram describing a network location information DB included in a network system according to the present invention.

FIG. 48 is a diagram describing a control signal in a control method according to the present invention.

FIG. 49 is a diagram describing a control signal in a control method according to the present invention.

FIG. 50 is a diagram describing a user belonging domain name DB included in a network system according to the present invention.

FIG. 51 is a diagram describing a control signal in a control method according to the present invention.

FIG. 52 is a diagram describing a control signal in a control method according to the present invention.

FIG. 53 is a diagram describing an authentication data transmission/reception unit operation state table included in a network system according to the present invention.

FIG. 54 is a diagram describing a screen of a smartphone of a user.

FIG. 55 is a diagram describing a control signal in a control method according to the present invention.

FIG. 56 is a diagram describing an authentication data temporary storage memory included in a network system according to the present invention.

FIG. 57 is a diagram describing a control signal in a control method according to the present invention.

FIG. 58 is a diagram describing a control signal in a control method according to the present invention.

FIG. 59 is a diagram describing a control signal in a control method according to the present invention.

FIG. 60 is a diagram describing a control signal in a control method according to the present invention.

FIG. 61 is a diagram describing a network location information DB included in a network system according to the present invention.

FIG. 62 is a diagram describing a control signal in a control method according to the present invention.

FIG. 63 is a diagram describing a user belonging domain name DB included in a network system according to the present invention.

FIG. 64 is a diagram describing a control signal in a control method according to the present invention.

FIG. 65 is a diagram describing a control signal in a control method according to the present invention.

FIG. 66 is a diagram describing a network path setting flow of a control method according to the present invention.

FIG. 67 is a diagram describing a screen of a smartphone of a user.

FIG. 68 is a diagram describing a control signal in a control method according to the present invention.

FIG. 69 is a diagram describing a control signal in a control method according to the present invention.

FIG. 70 is a diagram describing a control signal in a control method according to the present invention.

FIG. 71 is a diagram describing a control signal in a control method according to the present invention.

FIG. 72 is a diagram describing a control signal in a control method according to the present invention.

FIG. 73 is a diagram describing a control signal in a control method according to the present invention.

FIG. 74 is a diagram describing a control signal in a control method according to the present invention.

FIG. 75 is a diagram describing a control signal in a control method according to the present invention.

FIG. 76 is a diagram describing a screen of a smartphone of a user.

FIG. 77 is a diagram describing a control signal in a control method according to the present invention.

FIG. 78 is a diagram describing a control signal in a control method according to the present invention.

FIG. 79 is a diagram describing a network location information DB included in a network system according to the present invention.

FIG. 80 is a diagram describing a control signal in a control method according to the present invention.

FIG. 81 is a diagram describing a control signal in a control method according to the present invention.

FIG. 82 is a diagram describing a user belonging domain name DB included in a network system according to the present invention.

FIG. 83 is a diagram describing a control signal in a control method according to the present invention.

FIG. 84 is a diagram describing a gist of the present invention.

FIG. 85 is a diagram describing a network system according to the present invention.

### DESCRIPTION OF EMBODIMENTS

Embodiments of the present invention will be described with reference to the accompanying drawings. The embodiments described below are an example of the present invention, and the present invention is not limited to the embodiments describing below. Note that components having the same reference signs in the present description and the drawings indicate the same components.

In the present specification, an optical network is described as an example, but a dedicated network including IP may be used, or a network using VLAN, OTN, or MPLS may be used. In that case, the media controller (MC) is an IP encoder or an OTN mapper. In addition, the network location information is not an MC name but an IP address, a VLAN ID, or a physical port number.

In the present example, the authentication data exchanged in the authentication operation is described by a QR code and the input of a game controller, but the authentication data is not limited thereto, and may be, for example, a sound.

Note that a media signal and media information indicate a signal that is not an IP packet, such as a video, a sound, or a USB signal.

### First Embodiment

(Overall Image of Network System)

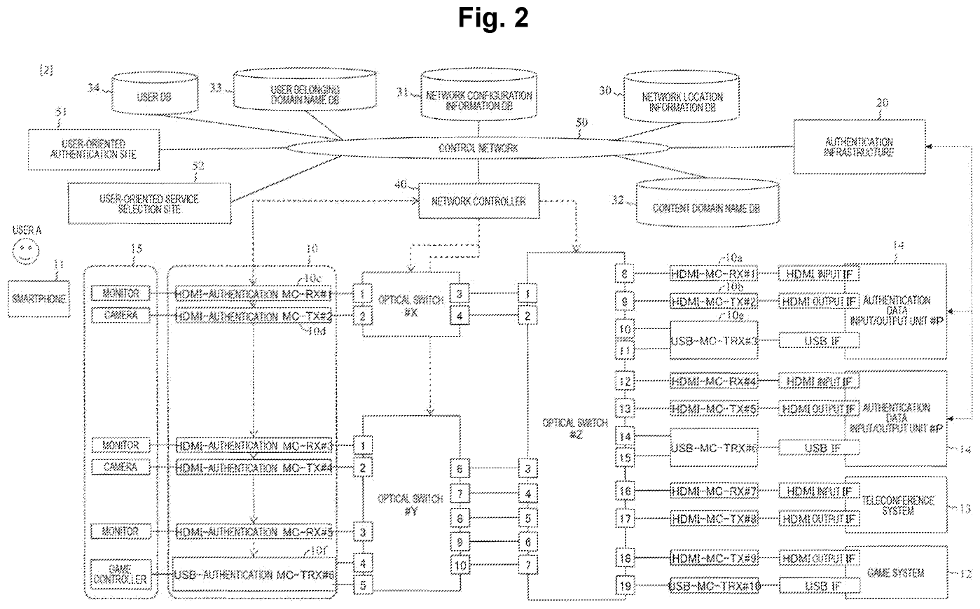

FIG. 2 is a diagram describing a network system of the present embodiment. The present network system is a device interface direct access type network system in which a device 15 not having a unique ID is connected via a media converter 10 having a port having a unique ID and identifiable in a network 50, the network system including:
an authentication infrastructure 20 that authenticates the device 15 in an authentication operation of transmitting and receiving, via a user terminal 11, authentication data converted into a media signal between the user terminal 11 of a user A and the device 10 by the media converter 10, and specifies the device 15 used by the user A from the media converter 10 specified in the authentication operation;
a database 30 that registers location information in which the location of the device 15 specified in the authentication operation is associated with a user name of the user A; and
a controller 40 that grasps the location of the device 15 from the database 30 on the basis of the user name of the user A when the user A makes a connection request to content in the network 50, and connects the content and the device 15 on the basis of the location.

A user-oriented authentication site 51 is a Web site having a function of mediating exchange of authentication data between the authentication infrastructure and a smartphone of the user.

A user-oriented service selection site 52 is a Web site that selects and designates a service that the user wants to use.

An authentication MC 10 is provided from a network provider and is reliable.

Optical switches (#X, #Y, #Z) are an optical switch that can change a connection relationship (for example, connecting 1 and 5, connecting 2 and 6, and the like) of optical ports by setting from a network controller 40.

A game system 12 is a general game machine having an HDMI video output terminal and a USB input/output terminal.

A teleconference system 13 is a teleconference system to which a video of a camera on the user A side is input and in which the video is combined with a video of another user, and the video is output to a monitor on the user A side.

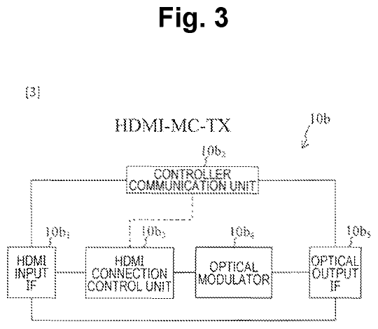

FIG. 3 is a diagram describing an HDMI-MC-TX 10b. The HDMI-MC-TX 10b includes an HDMI input IF 10b₁ to which a video and an audio signal from the system of the teleconference system 13 or an authentication data input/output unit 14 are input, 10b₂ that communicates with the controller 40, an HDMI connection control unit 10b₃ that establishes a connection between the camera and the HDMI by performing preset EDID (extended display identification data) negotiation and passes only the video and the audio signal input from the camera to an optical modulator 10b₄, the optical modulator 10b₄ that modulates the video and the audio signal input from the system into an optical signal, and an optical output IF 10b₅ that outputs the optical signal toward the optical switch.

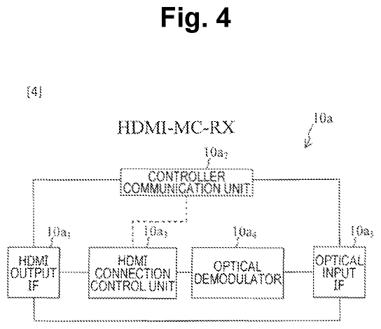

FIG. 4 is a diagram describing an HDMI-MC-RX 10a. The HDMI-MC-RX 10a includes an optical input IF 10a₅ to which an optical signal from the optical switch is input, 10a₂ that communicates with the controller 40, an optical demodulator 10a₄ that demodulates the optical signal into a video and an audio signal, an HDMI connection control unit 10a₃ that establishes a connection between the system of the game system 12, the teleconference system 13, and the authentication data input/output unit 14 and the HDMI by performing preset EDID negotiation and passes only the video and the audio signal input from the optical demodulator 10a₄ to an HDMI output IF 10a₁, and the HDMI output IF 10a₁ that outputs the video and the audio signal to the system.

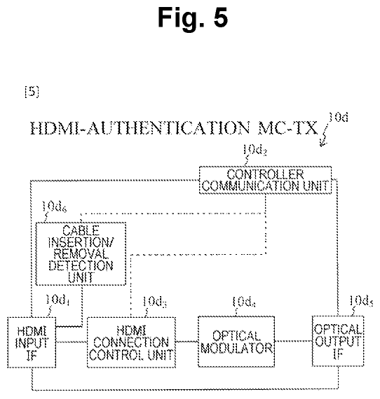

FIG. 5 is a diagram describing an HDMI-authentication MC-RX 10d of the authentication MC 10. The HDMI-authentication MC-RX 10d includes an HDMI input IF 10d₁ to which a video and an audio signal from the camera, which is the device 15 of the user A, are input, 10d₂ that communicates with the controller 40, an HDMI connection control unit 10d₃ that establishes a connection between the camera and the HDMI by performing preset EDID (extended display identification data) negotiation and passes only the video and the audio signal input from the camera to an optical modulator 10d₄, the optical modulator 10d₄ that modulates the video and the audio signal input from the camera into an optical signal, and an optical output IF 10d₅ that outputs the optical signal toward the optical switch. The HDMI-authentication MC-RX 10d further includes a cable insertion/removal detection unit 10d₆ that detects insertion/removal of a cable (HDMI plug) and notifies the controller 40 of that fact. The cable insertion/removal detection unit 10d₆, for example, electrically senses the cable, or senses the cable by turning on/off a switch in the HDMI input IF 10d₁.

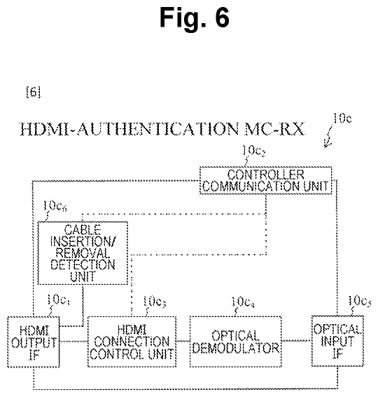

FIG. 6 is a diagram describing an HDMI-authentication MC-RX 10c of the authentication MC 10. The HDMI-authentication MC-RX 10c includes an optical input IF 10c₅ to which an optical signal from the optical switch is input, 10c₂ that communicates with the controller 40, an optical demodulator 10c₄ that demodulates the optical signal into a video and an audio signal, an HDMI connection control unit 10c₃ that establishes a connection between a monitor and the HDMI by performing preset EDID negotiation and passes only the video and the audio signal input from the optical demodulator 10c₄ to an HDMI output IF 10c₁, and the HDMI output IF 10c₁ that outputs the video and the audio signal to the system. The HDMI-authentication MC-RX 10c further includes a cable insertion/removal detection unit 10c₆ that detects insertion/removal of a cable (HDMI plug) and notifies the controller 40 of that fact. The cable insertion/removal detection unit 10c₆, for example, electrically senses the cable, or senses the cable by turning on/off a switch in the HDMI output IF 10c₁.

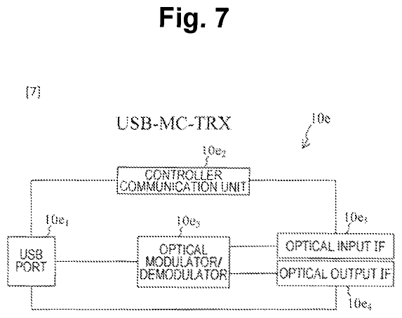

FIG. 7 is a diagram describing a USB-MC-TRX 10e. The USB-MC-TRX 10e includes a USB port 10e₁ to which an information signal from the system of the game system 12 or the authentication data input/output unit 14 is input, 10e₂ that communicates with the controller 40, an optical modulator/demodulator 10e₃ that modulates the information signal input from the USB port 10e₁ into an optical signal, passes the optical signal to an optical output IF 10e₄, demodulates the optical signal input from an optical input IF 10e₅ into an information signal, and passes the information signal to the USB port 10e₁, the optical output IF 1e₄ that outputs the optical signal toward the optical switch, and the optical input IF 10e₅ to which the optical signal from the switch is input.

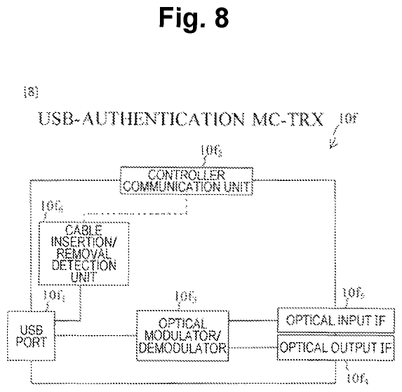

FIG. 8 is a diagram describing a USB-authentication MC-TRX 10f of the authentication MC 10. The USB-authentication MC-TRX 10f includes a USB port 10f₁ to which an information signal from a game controller is input, 10f₂ that communicates with the controller 40, an optical modulator/demodulator 10f₃ that modulates the information signal input from the USB port 10f₁ into an optical signal, passes the optical signal to an optical output IF 10f₄, demodulates the optical signal input from an optical input IF 10f₅ into an information signal, and passes the information signal to the USB port 10f₁, the optical output IF 10f₄ that outputs the optical signal toward the optical switch, and the optical input IF 10f₅ to which the optical signal from the switch is input. The USB-authentication MC-TRX 10f further includes a cable insertion/removal detection unit 10f₆ that detects insertion/removal of a cable (USB plug) and notifies the controller 40 of that fact. The cable insertion/removal detection unit 10f₆, for example, electrically senses the cable, or senses the cable by turning on/off a switch in the USB port 10f₁.

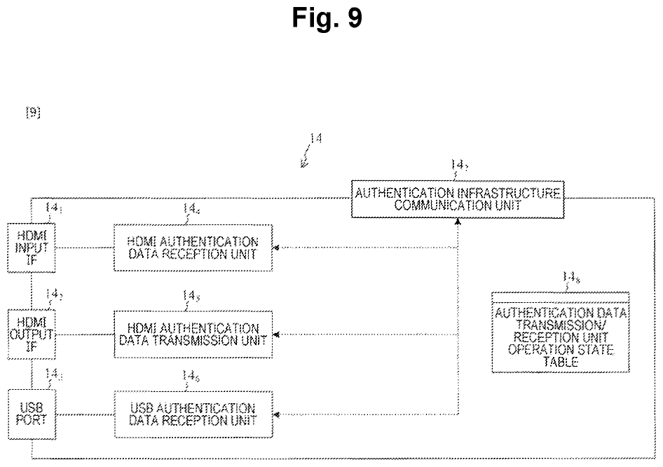

FIG. 9 is a diagram describing the authentication data input/output unit 14. The authentication data input/output unit 14 includes an HDMI input IF 14₁ to which a video and an audio signal from the HDMI-MC-RX 10a are input, an HDMI output IF 14₂ that outputs a video and an audio signal from an HDMI authentication data transmission unit 14₃ to the HDMI-MC-TX 10b, a USB port 14₃ that passes an information signal between the USB-MC-TRX 10e and a USB authentication data reception unit 14₆, an authentication infrastructure communication unit 14₇ that communicates with the authentication infrastructure 20, and an authentication data transmission/reception unit operation state table 14₈.

An HDMI authentication data reception unit 14₄ extracts and recognizes the authentication data from the HDMI video and the audio signal input from the HDMI input IF 14₁, and transmits the obtained authentication data to the authentication infrastructure 20 via the authentication infrastructure communication unit 14₇.

The HDMI authentication data transmission unit 14₃ converts the authentication data transmitted from the authentication infrastructure 20 into an HDMI video and an audio signal and outputs the HDMI video and the audio signal from the HDMI output IF 14₂.

The USB authentication data reception unit 14₆ extracts and recognizes the authentication data from the information signal input from the USB port 14₃, and transmits the obtained authentication data to the authentication infrastructure 20 via the authentication infrastructure communication unit 14₇.

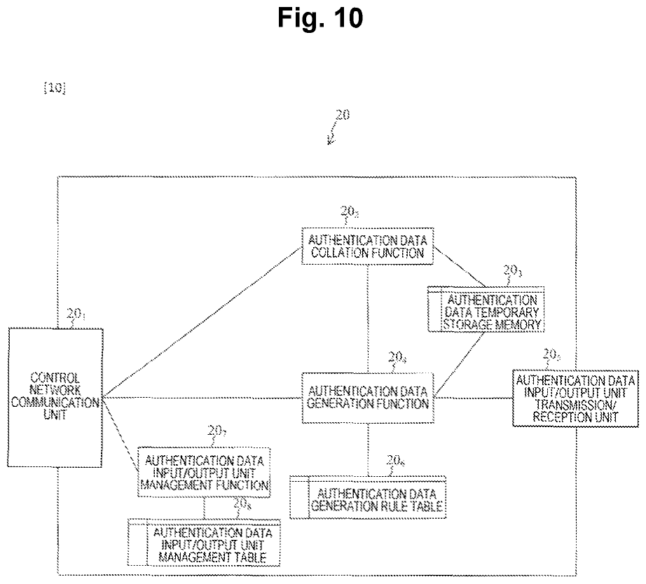

FIG. 10 is a diagram describing the authentication infrastructure 20. The authentication infrastructure 20 includes a control network communication unit 20₁ connected to the network 50, an authentication data collation function 20₂, an authentication data temporary storage memory 20₃, an authentication data generation function 20₄, an authentication data input/output unit transmission/reception unit 20₅ connected to the authentication data input/output unit 14, an authentication data generation rule table 20₆, an authentication data input/output unit management function 20₇, and an authentication data input/output unit management table 20₈. The operation of each functional unit will be described below.

(Detailed Operation of System)

A control method for the network system in FIG. 2 includes:
authenticating a device in an authentication operation of transmitting and receiving, via a user terminal, authentication data converted into a media signal between the user terminal of a user and the device by the media converter, and specifying the device used by the user from the media converter specified in the authentication operation (step S01);
registering location information in which the location of the device specified in the authentication operation is associated with a user name of the user (step S02); and
grasping the location of the device from the database on the basis of the user name of the user when the user makes a connection request to content in the network, and connecting the content and the device on the basis of the location (step S03).

Here, when the device is connected to the media converter, the authentication infrastructure performs the authentication operation (step S01), and the database registers the location information of the device (step S02).

Then, when the device is removed from the media converter, the database deletes the location information of the device (step S04).

The present control method includes the four flows described below.

(1) Pre-Operation Flow

The present flow is prepared in a stage before operation.

(2) Network Location Information DB Dynamic Configuration Flow

The present flow is performed when the network location information of the device used by the user is registered (steps S01 and S02).

(3) Network Path Setting Flow

The present flow is performed when a service wants to set a network path.

(4) Network Location Information DB Deletion Flow

The present flow is performed when the device is removed (step S04).

Each flow will be described in detail below.

(1) Pre-Operation Flow

The pre-operation flow constructs the five pieces of information described below that do not change, such as content and information of the authentication data input/output unit.

(1-1) Static Construction of Network Location Information DB

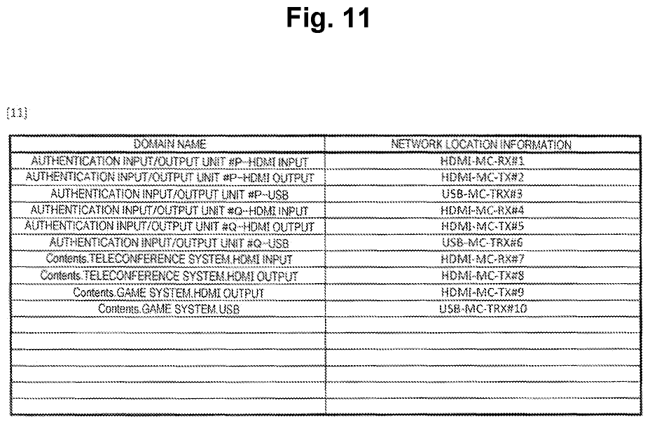

FIG. 11 is a diagram describing a specific example of a network location information DB 30.

(1-2) Construction of Network Configuration Information DB

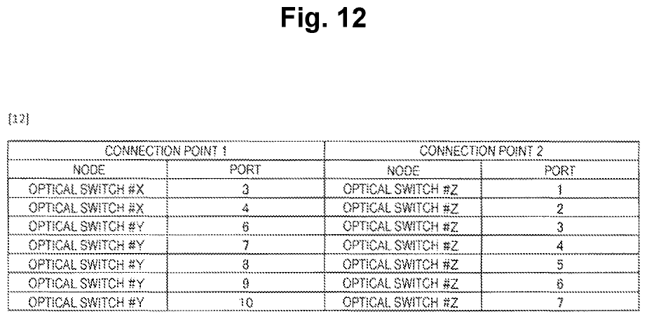

FIG. 12 is a diagram describing a specific example of an intra-network configuration information in a network configuration information DB 31.

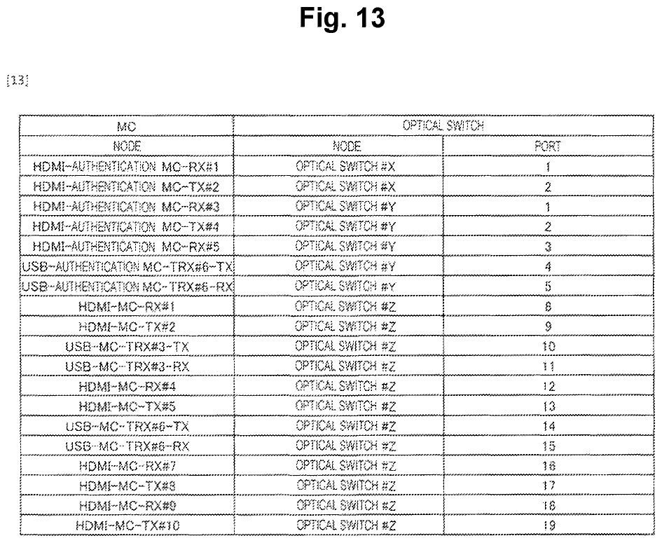

FIG. 13 is a diagram describing a specific example of access point configuration information in the network configuration information DB 31.

(1-3) Construction of Content Domain Name

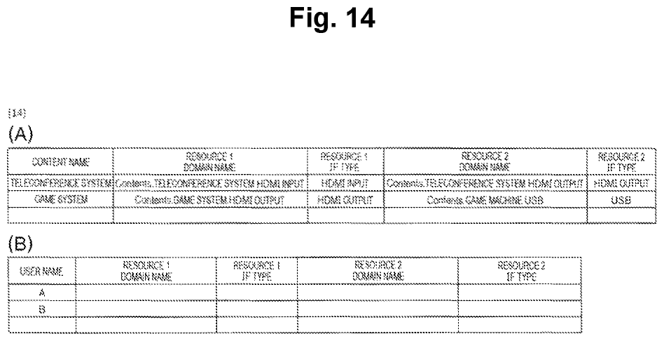

FIG. 14(A) is a diagram describing a specific example of a content domain name DB 32.

Here, a user belonging domain name DB 34 (FIG. 14(B)) may be constructed.

(1-4) Construction of Authentication Data Generation Rule Table

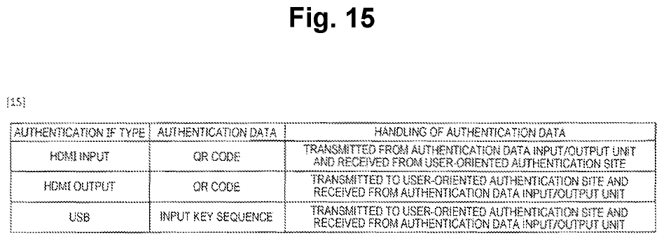

FIG. 15 is a diagram describing a specific example of the authentication data generation rule table 20₆.

(1-5) Construction of Authentication Data Input/Output Unit Management Table

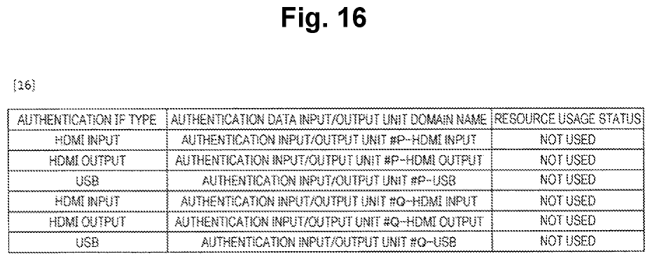

FIG. 16 is a diagram describing a specific example of the authentication data input/output unit management table 20₈.

(2) Network Location Information DB Dynamic Configuration Flow

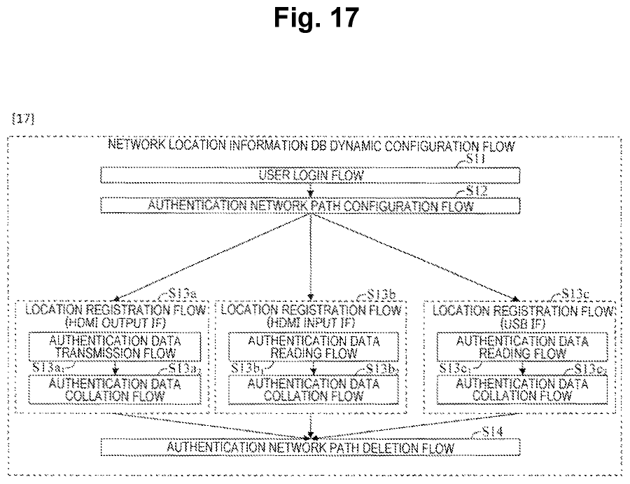

FIG. 17 is a diagram describing the present flow. The present flow includes a user login flow S11, an authentication network path configuration flow S12, location registration flows (S13a to S13c), and an authentication network path deletion flow S14.

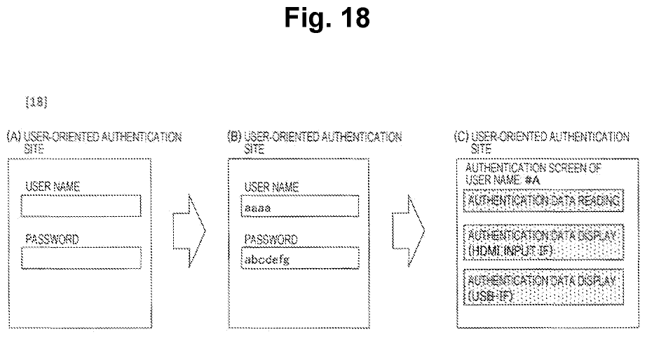

FIG. 18 is a diagram describing the user login flow S11. The user A accesses a user-oriented authentication site (FIG. 18(A)) using its own smartphone 11.

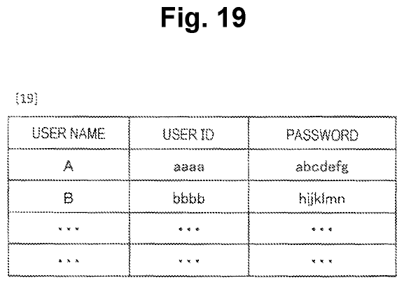

Next, the user A inputs its own ID and password in the user-oriented authentication site (FIG. 18(B)). The user-oriented authentication site refers to a user DB 34, and in a case where the ID and the password match, the user-oriented authentication site authorizes login of the user A and displays an authentication screen for the user A (FIG. 18(C)). FIG. 19 is an example of information held by the user DB 34.

Next, the authentication network path configuration flow S12 will be described.

Step S12-1

The user A inserts a cable of the device 15 to be used (for example, a monitor) into the authentication MC 10 (for example, HDMI-authentication MC-RX 10c).

Step S12-2

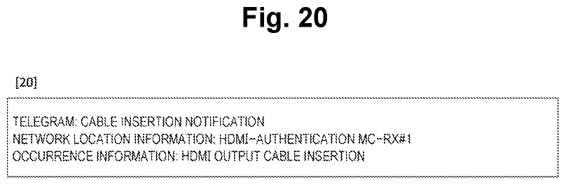

The authentication MC 10 transmits the fact that the cable has been inserted and its own location information on the network together to the network controller 40 as a cable insertion notification (see, for example, FIG. 20).

Step S12-3

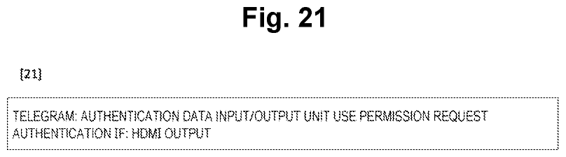

When receiving the cable insertion notification, the network controller 40 transmits, to the authentication infrastructure 20, an authentication data input/output unit use permission request (see, for example, FIG. 21) to which the IF type described in the cable insertion notification is added.

Step S12-4

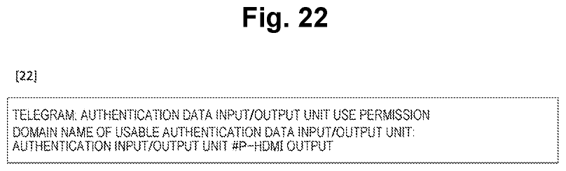

The authentication data input/output unit management function 20₇ of the authentication infrastructure 20 refers to the authentication data input/output unit management table 20₈ (for the description content, see, for example, FIG. 16) to select a domain name of the available authentication data input/output unit, and transmits the domain name as an authentication data input/output unit use permission (see, for example, FIG. 22). Then, the authentication data input/output unit management function 20₇ changes the resource usage status of the selected authentication data input/output unit to “in use” with respect to the authentication data input/output unit management table 20₈ (for example, changed from FIG. 16 to FIG. 26).

Step S12-5

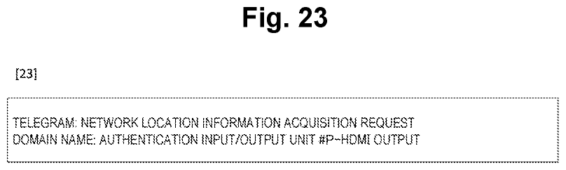

The network controller 40 transmits a network location information acquisition request (see, for example, FIG. 23) having an authentication data input/output unit name described in the received authentication data input/output unit use permission (see, for example, FIG. 22) as the domain name to the network location information DB 30.

Step S12-6

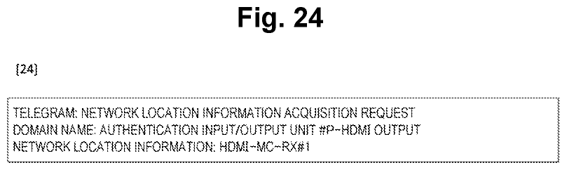

The network location information DB 30 transmits network location information obtained using the domain name as a network location information response (see, for example, FIG. 24).

Step S12-7

Upon acquiring the network location information response (see, for example, FIG. 24), the network controller 40 designs a path for connecting the network location information described in the cable insertion notification (see, for example, FIG. 20) and the network location information acquired in the network location information response (see, for example, FIG. 24) with reference to the network configuration information DB 31, and sets the optical switch.

For example, the network controller 40 performs the setting described below.

“Connect port 1 and port 3 in optical switch #X” “Connect port 1 and port 9 in optical switch #X”

Step S12-7

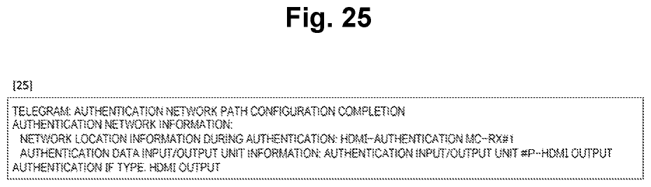

The network controller 40 transmits the fact that an authentication network path is configured, the configured authentication network information, and the IF type to be authenticated to the authentication infrastructure 20 as an authentication network path configuration completion notification (see, for example, FIG. 25).

Next, the location registration flows S13 will be described. First, an authentication data transmission flow S13a₁ of the location registration flow S13a of the HDMI output IF will be described.

Step S13a₁-1

The authentication data generation function 20₄ of the authentication infrastructure 20 receives the authentication network path configuration completion notification (see, for example, FIG. 25), and generates the authentication data on the basis of the description of the authentication data generation rule table 20₆ when the authentication IF type of the notification is HDMI output. In the case of the HDMI output, a QR code for authentication is generated and transmitted from an authentication data input/output unit 20₅.

Step S13a₁-2

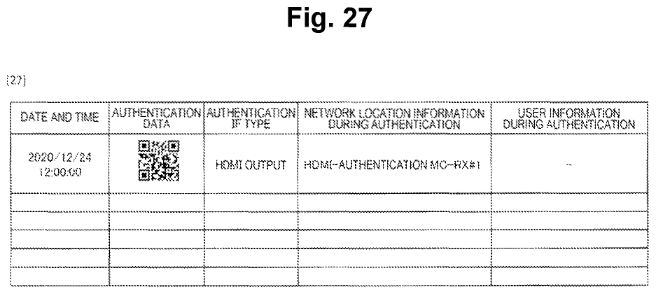

The authentication data generation function 20₄ stores the generated authentication data, the authentication IF type described in the authentication network path configuration completion notification (see, for example, FIG. 25), and the network location information during authentication in the authentication data temporary storage memory 20₃ (see, for example, FIG. 27).

Step S13a₁-3

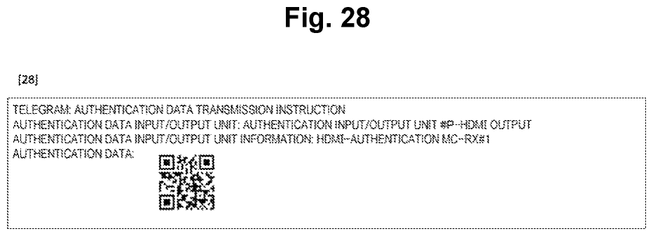

The authentication data generation function 20₄ notifies the authentication data input/output unit 14 described in the authentication network path configuration completion notification (see, for example, FIG. 25) of an authentication data transmission instruction (see, for example, FIG. 28) including the generated authentication data and the network location information during authentication.

Step S13a₁-4

The HDMI authentication data transmission unit 14₃ of the authentication data input/output unit 14 generates an HDMI signal including the authentication data described in the notification, and transmits the HDMI signal from the HDMI output IF 14₂.

Step S13a₁-5

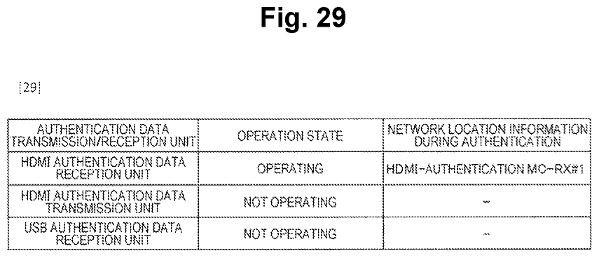

The authentication data input/output unit 14 updates the authentication data transmission/reception unit operation state table 14₈ on the basis of the authentication data transmission instruction (see, for example, FIG. 29).
Step S13a₁-6

The authentication data is displayed on the monitor used by the user A via the authentication network path.

Next, an authentication data collation flow S13a2 of the location registration flow S13a of the HDMI output IF will be described.

Step S13a₂-1

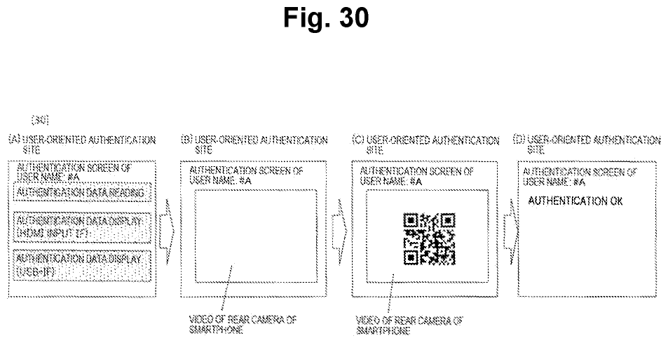

When the user A visually recognizes that the authentication data is displayed on the monitor used by the user A, the user A selects to read the authentication data on the user-oriented authentication site after login (see, for example, FIGS. 18(C) and 30(A)).

Step S13a₂-2

The user-oriented authentication site accesses the camera of the smartphone 11 and starts acquisition of a camera video (see, for example, FIG. 30(B)).

Step S13a₂-3

The user A directs the camera of the smartphone 11 toward the monitor, and photographs the displayed authentication data (see, for example, FIG. 30(C)).

Step S13a₂-4

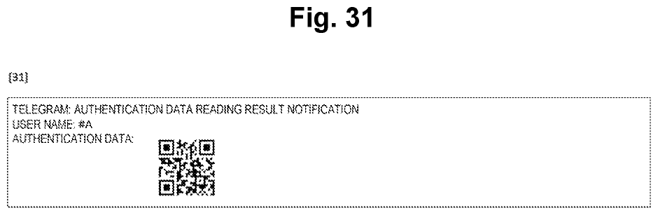

The user-oriented authentication site transmits the photographed image of the camera and the user name to the authentication infrastructure 20 as an authentication data reading result notification (see, for example, FIG. 31).

Step S13a₂-5

The authentication data collation function 20₂ of the authentication infrastructure 20 searches the authentication data temporary storage memory 20₃ (see, for example, FIG. 27), and confirms whether there is registration data matching the authentication data described in the authentication data reading result notification (see, for example, FIG. 31).

Step S13a₂-6

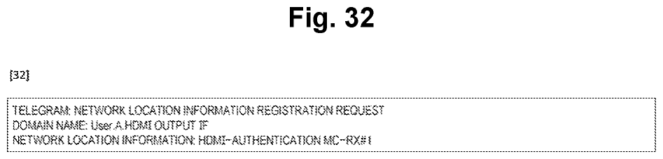

When there is matching registration data, the authentication data collation function 20₂ of the authentication infrastructure 20 generates a network location information registration request (see, for example, FIG. 32) from the user name described in the authentication data reading result notification (see, for example, FIG. 31), the domain name configured using the authentication IF type, and the network location information during authentication, and transmits the network location information registration request to the network location information DB 30.

Step S13a₂-7

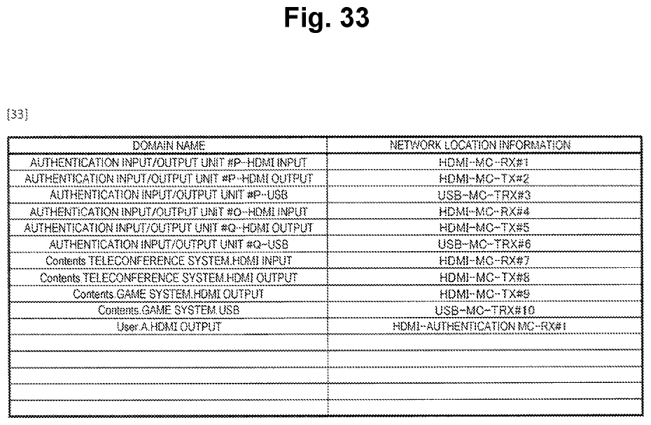

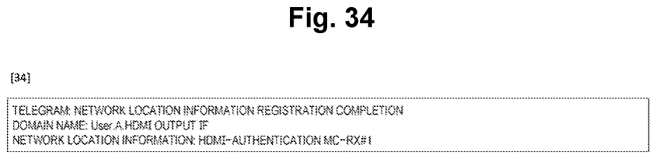

Upon receiving the network location information registration request (see, for example, FIG. 32), the network location information DB 30 registers the content thereof (see, for example, FIG. 33), and when the registration is completed, notifies the authentication data collation function 20₂ of network location information registration completion (see, for example, FIG. 34).

Step S13a₂-8

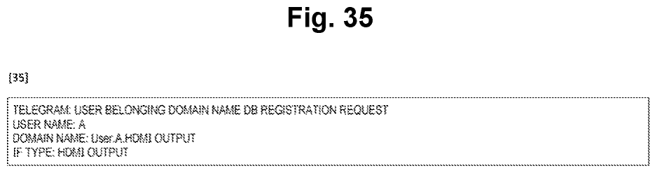

The authentication data collation function 20₂ transmits a user belonging domain name DB registration request (see, for example, FIG. 35) including the domain name, the user name, and the authentication IF type to a user belonging domain name DB 33.

Step S13a₂-9

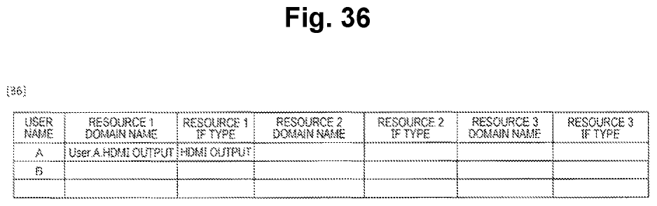

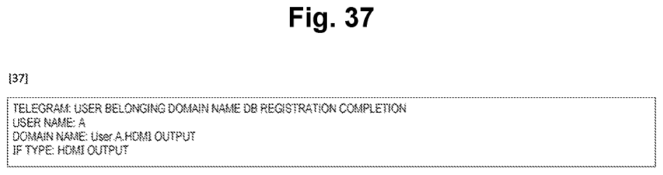

Upon receiving the user belonging domain name DB registration request (see, for example, FIG. 35), the user belonging domain name DB 33 registers the content thereof (see, for example, FIG. 36), and when the registration is completed, notifies the authentication data collation function 20₂ of user belonging domain name DB registration completion (see, for example, FIG. 37).

Step S13a₂-10

Upon receiving the network location information registration completion (see, for example, FIG. 34) and the user belonging domain name DB registration completion (see, for example, FIG. 37), the authentication data collation function 20₂ erases the data from the authentication data temporary storage memory 20₃.

Step S13a₂-11

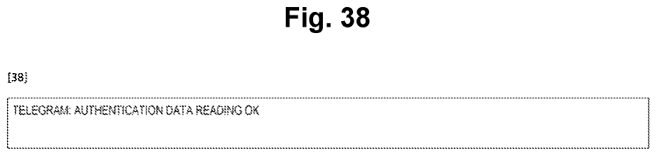

The authentication data collation function 20₂ transmits authentication data reading OK (see, for example, FIG. 38) to the user-oriented authentication site 51.

Step S13a₂-12

When receiving the network location information registration completion (see, for example, FIG. 34), the user-oriented authentication site 51 displays authentication OK on the smartphone 11 of the user A.

Step S13a₂-13

The authentication data collation function 20₂ transmits an authentication data transmission end instruction to the authentication data input/output unit 14.

Step S13a₂-14

The authentication data input/output unit 14 ends the authentication data transmission and updates the authentication data transmission/reception unit operation state table 14₈.

Step S13a₂-15

The authentication data collation function 20₂ instructs the authentication data input/output unit management function 20₇ to release the authentication data input/output unit 14, and the authentication data input/output unit management function 20₇ updates the authentication data input/output unit management table 20₈.

Next, the location registration flow S13b of the HDMI input IF will be described. First, an authentication data reading flow S13b1 will be described.

Step S13b₁-1

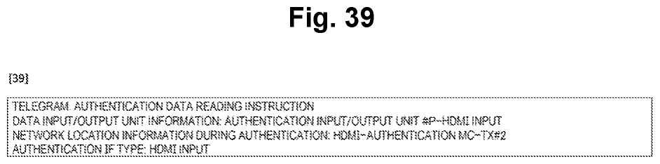

The authentication data generation function 20₄ of the authentication infrastructure 20 receives the authentication network path configuration completion notification (see, for example, FIG. 25), and transmits an authentication data reading instruction (see, for example, FIG. 39) to the authentication data input/output unit 14 described in the notification when the authentication IF type of the notification is HDMI input.

Step S13b₁-2

When the HDMI input IF is designated by receiving the authentication data reading instruction (see, for example, FIG. 39), the authentication data input/output unit 14 starts the operation of the HDMI authentication data reception unit 14₄ of the authentication data input/output unit 14.

Step S13b₁-3

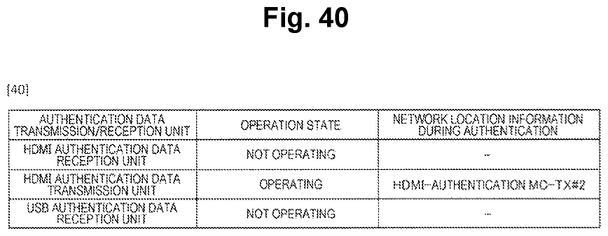

The authentication data input/output unit 14 updates the authentication data transmission/reception unit operation state table 14₈ (see, for example, FIG. 40) on the basis of the authentication data reading instruction (see, for example, FIG. 39).

Next, an authentication data collation flow S13b2 of the location registration flow S13b of the HDMI input IF will be described.

Step S13b₂-1

The user A presses the authentication data display (HDMI input IF) on the user-oriented authentication site after insertion of the cable (see, for example, FIGS. 18(C) and 40(A)).

Step S13b₂-2

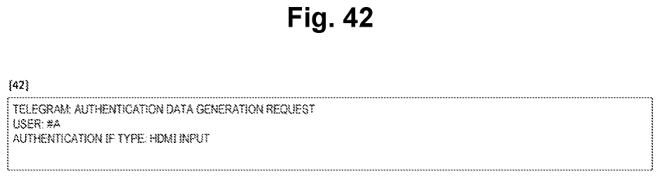

The user-oriented authentication site transmits an authentication data generation request (see, for example, FIG. 42) to the authentication data generation function 20₄ of the authentication infrastructure 20.

Step S13b₂-3

The authentication data generation function 20₄ generates authentication data on the basis of the authentication IF type described in the authentication data generation request (see, for example, FIG. 42) and the authentication data generation rule table 20₆. In the HDMI input, the QR code for authentication is generated, transmitted to the user-oriented authentication site, and received from the authentication data input/output unit 14.

Step S13b₂-4

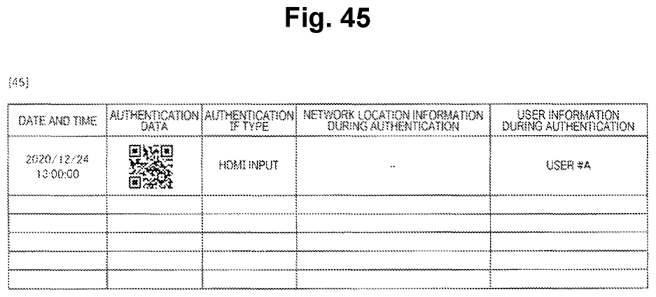

The authentication data generation function 20₄ stores the generated authentication data and the user name described in the authentication data generation request (see, for example, FIG. 42) in the authentication data temporary storage memory 20₃ (see, for example, FIG. 45).

Step S13b₂-5

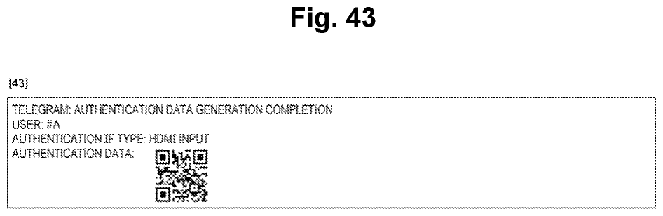

The authentication data generation function 20₄ adds the generated authentication data and transmits authentication data generation completion (see, for example, FIG. 43) to the user-oriented authentication site.

Step S13b₂-6

The user-oriented authentication site displays the authentication data described in the received authentication data generation completion (see, for example, FIG. 43).

Step S13b₂-7

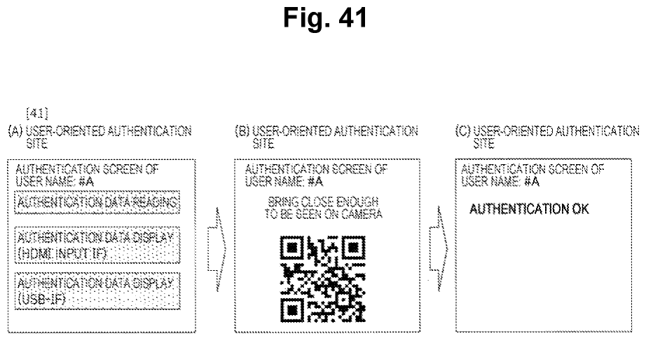

When the authentication data is displayed, the user A brings the smartphone close to the camera (see, for example, FIG. 41(B)). Then, the video including the authentication data reaches the HDMI authentication data reception unit 14₄ of the authentication data input/output unit 14 from the camera via the authentication network path.

Step S13b₂-8

The HDMI authentication data reception unit 14₄ of the authentication data input/output unit 14 reads the authentication data from the video including the authentication data.

Step S13b₂-9

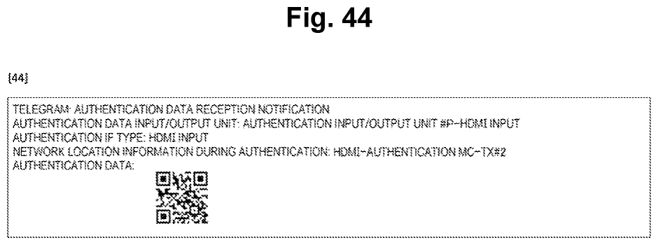

The HDMI authentication data reception unit 14₄ transmits an authentication data reception notification (see, for example, FIG. 44) to the authentication infrastructure 20 on the basis of the read authentication data and the description of the authentication data transmission/reception unit operation state table 14₈.

Step S13b₂-10

The authentication data collation function 20₂ of the authentication infrastructure 20 searches the authentication data temporary storage memory 20₃ (see, for example, FIG. 45), and confirms whether there is registration data matching the authentication data described in the authentication data reception notification (see, for example, FIG. 44).

Step S13b₂-11

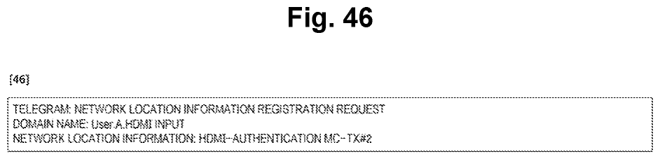

When there is matching registration data, the authentication data collation function 20₂ of the authentication infrastructure 20 generates a network location information registration request (see, for example, FIG. 46) from the network location information during authentication described in the authentication data reception notification (see, for example, FIG. 44), the user name described in the authentication data temporary storage memory 20₃ (see, for example, FIG. 45), and the domain name configured using the authentication IF type, and transmits the network location information registration request to the network location information DB 30.

Step S13b₂-12

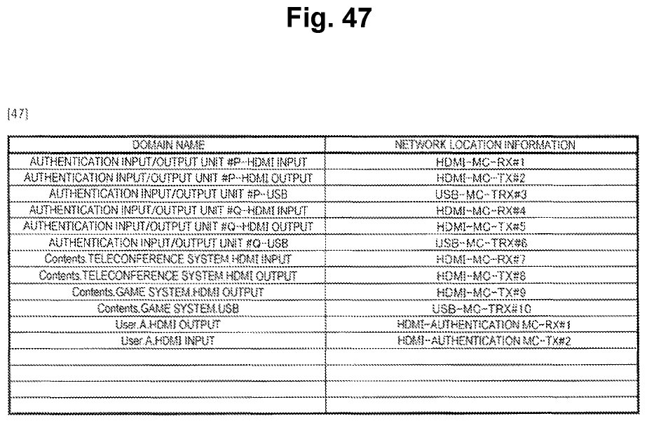

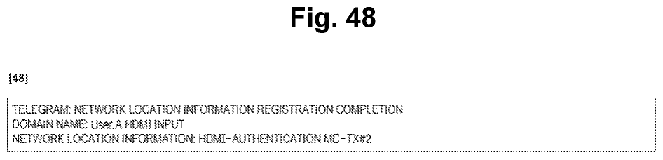

Upon receiving the network location information registration request (see, for example, FIG. 46), the network location information DB 30 registers the information thereof (see, for example, FIG. 47), and when the registration is completed, notifies the authentication data collation function 20₂ of network location information registration completion (see, for example, FIG. 48).

Step S13b₂-13

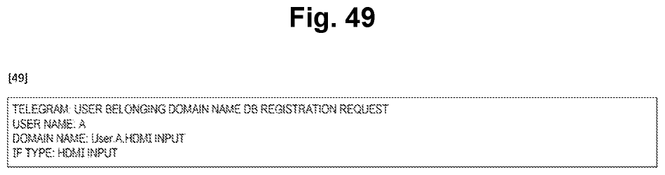

The authentication data collation function 20₂ transmits a user belonging domain name DB registration request (see, for example, FIG. 49) including the domain name, the user name, and the authentication IF type to a user belonging domain name DB 33.

Step S13b₂-14

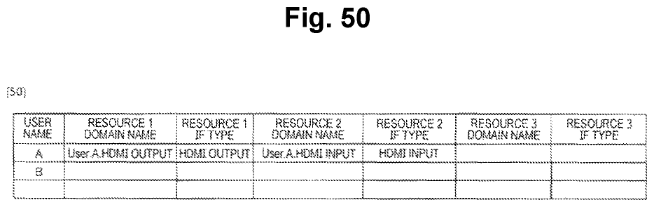

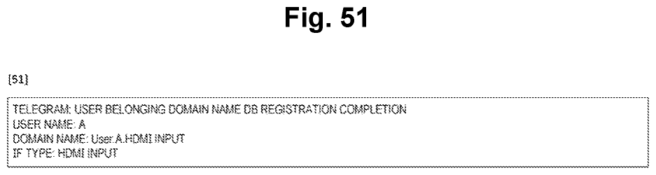

Upon receiving the user belonging domain name DB registration request (see, for example, FIG. 49), the user belonging domain name DB 33 registers the information thereof (see, for example, FIG. 50), and when the registration is completed, notifies the authentication data collation function 20₂ of user belonging domain name DB registration completion (see, for example, FIG. 51).

Step S13b₂-15

Upon receiving the network location information registration completion (see, for example, FIG. 48) and the user belonging domain name DB registration completion (see, for example, FIG. 51), the authentication data collation function 20₂ erases the data from the authentication data temporary storage memory 20₃.

Step S13b₂-16

The authentication data collation function 20₂ transmits authentication data reading OK to the user-oriented authentication site.

Step S13b₂-17

When the authentication data reading OK is received, the user-oriented authentication site displays authentication OK on the smartphone of the user A (for example, FIG. 41(C)).

Step S13b₂-18

The authentication data collation function 20₂ transmits an authentication data reading end instruction to the authentication data input/output unit 14.

Step S13b₂-19

The authentication data input/output unit 14 ends the authentication data reading and updates the authentication data transmission/reception unit operation state table 14₈.

Step S13b₂-20

The authentication data collation function 20₂ instructs the authentication data input/output unit management function 20₇ to release the authentication data input/output unit 14, and the authentication data input/output unit management function 20₇ updates the authentication data input/output unit management table 20₈.

Next, the location registration flow S13c of the USB IF will be described. First, an authentication data reading flow S13c1 will be described.

Step S13c₁-1

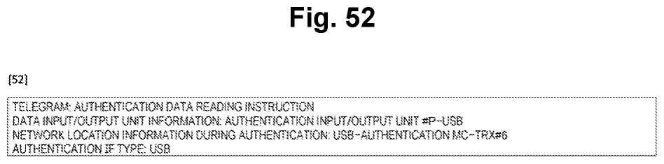

The authentication data generation function 20₄ of the authentication infrastructure 20 receives the authentication network path configuration completion notification, (see, for example, FIG. 25), and transmits an authentication data reading instruction (see, for example, FIG. 52) to the authentication data input/output unit 14 described in the notification when the authentication IF type of the notification is USB IF.

Step S13c₁-2

When the USB IF is designated by receiving the authentication data reading instruction (see, for example, FIG. 52), the authentication data input/output unit 14 starts the operation of the USB authentication data reception unit 14₆.

Step S13c₁-3

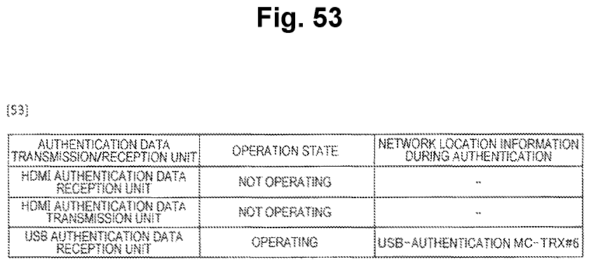

The authentication data input/output unit 14 updates the authentication data transmission/reception unit operation state table 14₈ (see, for example, FIG. 53) on the basis of the authentication data reading instruction (see, for example, FIG. 52).

Next, an authentication data collation flow S13c2 of the location registration flow S13c of the USB IF will be described.

Step S13c₂-1

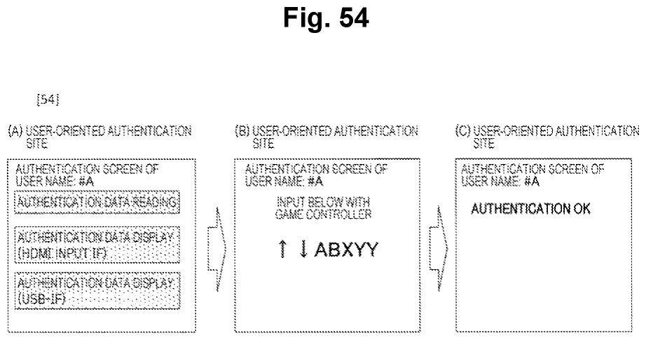

The user A presses the authentication data display (USB input IF) on the user-oriented authentication site after insertion of the cable (see, for example, FIG. 54(A)).

Step S13c₂-2

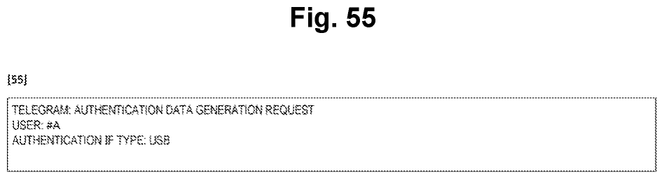

The user-oriented authentication site transmits an authentication data generation request (see, for example, FIG. 55) to the authentication data generation function 20₄ of the authentication infrastructure 20.

Step S13c₂-3

The authentication data generation function 20₄ generates authentication data on the basis of the authentication IF type described in the authentication data generation request (see, for example, FIG. 55) and the authentication data generation rule table 20₆ (see, for example, FIG. 15). In the USB input, the authentication data generation function 20₄ generates an input key sequence for authentication, transmits the input key sequence to the user-oriented authentication site, and receives the input key sequence from the authentication data input/output unit 14.

Step S13c₂-4

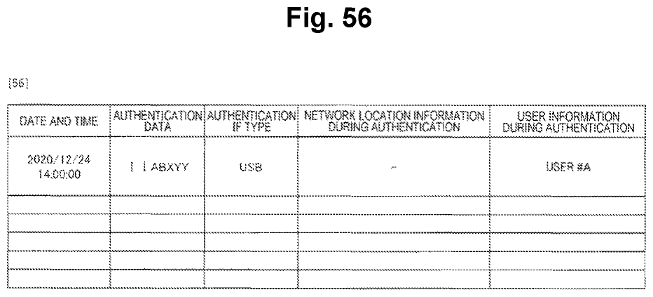

The authentication data generation function 20₄ stores the generated authentication data and the user name described in the authentication data generation request (see, for example, FIG. 55) in the authentication data temporary storage memory 20₃ (see, for example, FIG. 56).

Step S13c₂-5

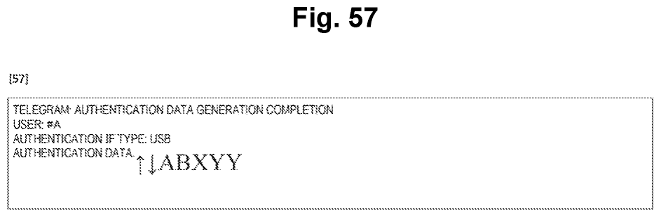

The authentication data generation function 20₄ adds the generated authentication data and transmits authentication data generation completion (see, for example, FIG. 57) to the user-oriented authentication site.

Step S13c₂-6

The user-oriented authentication site displays the authentication data described in the received authentication data generation completion (see, for example, FIG. 57) (see, for example, FIG. 54(B)).

Step S13c₂-7

The user A inputs the displayed authentication data with the game controller. Then, the video including the authentication data reaches the USB authentication data reception unit 14₆ of the authentication data input/output unit 14 from the camera via the authentication network path.

Step S13c₂-8

The USB authentication data reception unit 14₆ of the authentication data input/output unit 14 reads the authentication data from the input USB signal.

Step S13c₂-9

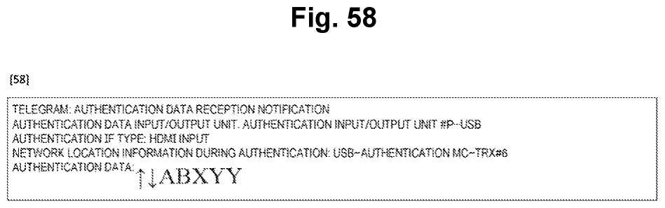

The USB authentication data reception unit 14₆ transmits an authentication data reception notification (see, for example, FIG. 58) to the authentication infrastructure 20 on the basis of the read authentication data and the description of the authentication data transmission/reception unit operation state table 14₈ (see, for example, FIG. 53).

Step S13c₂-10

The authentication data collation function 20₂ of the authentication infrastructure 20 searches the authentication data temporary storage memory 20₃ (see, for example, FIG. 56), and confirms whether there is registration data matching the authentication data described in the authentication data reception notification (see, for example, FIG. 58).

Step S13c₂-11

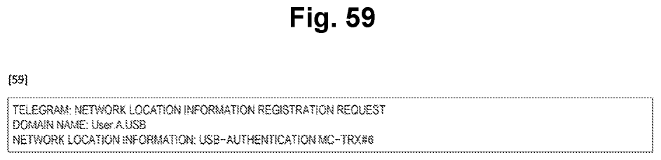

When there is matching registration data, the authentication data collation function 20₂ of the authentication infrastructure 20 generates a network location information registration request (see, for example, FIG. 59) from the network location information during authentication described in the authentication data reception notification (see, for example, FIG. 58), the user name described in the authentication data temporary storage memory 20₃ (see, for example, FIG. 56), and the domain name configured using the authentication IF type, and transmits the network location information registration request to the network location information DB 30.

Step S13c₂-12

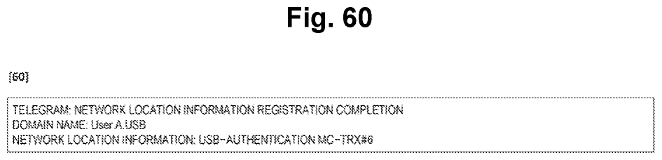

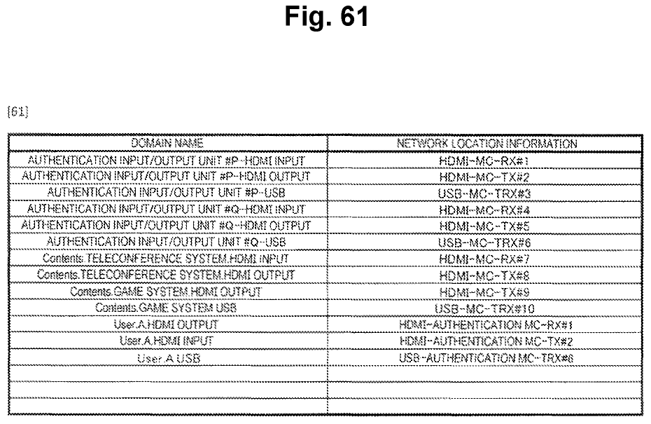

Upon receiving the network location information registration request (see, for example, FIG. 59), the network location information DB 30 registers the information thereof (see, for example, FIG. 61), and when the registration is completed, notifies the authentication data collation function 20₂ of network location information registration completion (see, for example, FIG. 60).

Step S13c₂-13

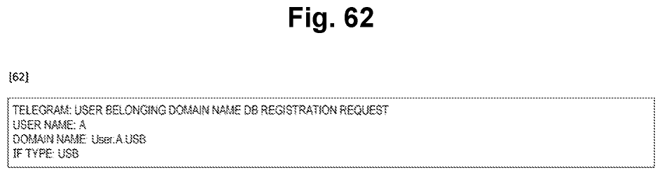

The authentication data collation function 20₂ transmits a user belonging domain name DB registration request (see, for example, FIG. 62) including the domain name, the user name, and the authentication IF type to the user belonging domain name DB 33.

Step S13c₂-14

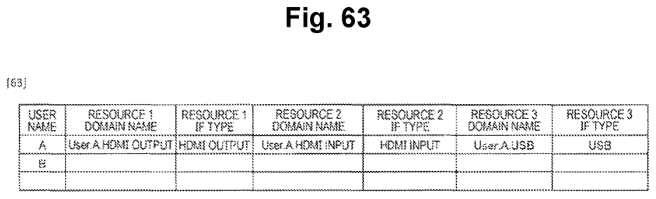

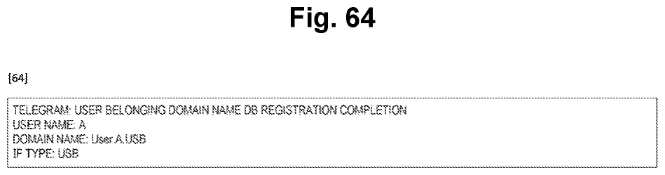

Upon receiving the user belonging domain name DB registration request (see, for example, FIG. 62), the user belonging domain name DB 33 registers the information thereof (see, for example, FIG. 63), and when the registration is completed, notifies the authentication data collation function 20₂ of user belonging domain name DB registration completion (see, for example, FIG. 64).

Step S13c₂-15

Upon receiving the network location information registration completion (see, for example, FIG. 60) and the user belonging domain name DB registration completion (see, for example, FIG. 64), the authentication data collation function 20₂ erases the data from the authentication data temporary storage memory 20₃.

Step S13c₂-16

The authentication data collation function 20₂ transmits authentication data reading OK to the user-oriented authentication site.

Step S13c₂-17

When receiving the network location information registration completion, the user-oriented authentication site displays authentication OK on the smartphone 11 of the user A (see, for example, FIG. 54(C)).

Step S13c₂-18

The authentication data collation function 20₂ transmits an authentication data reading end instruction to the authentication data input/output unit 14.

Step S13c₂-19

The authentication data input/output unit 14 ends the authentication data reading and updates the authentication data transmission/reception unit operation state table 14₈ (see, for example, FIG. 53).

Step S13c₂-20

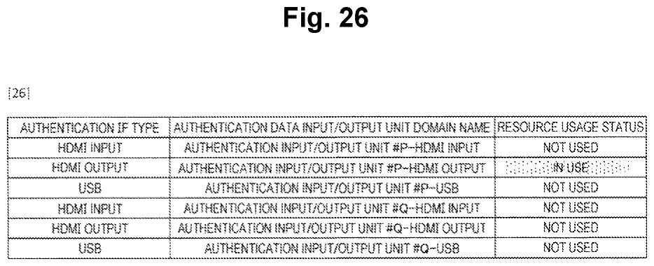

The authentication data collation function 20₂ instructs the authentication data input/output unit management function 20₇ to release the authentication data input/output unit 14, and the authentication data input/output unit management function 20₇ updates the authentication data input/output unit management table 20₈ (see, for example, FIG. 26).

Finally, the authentication network path deletion flow S14 will be described.

Step S14-1

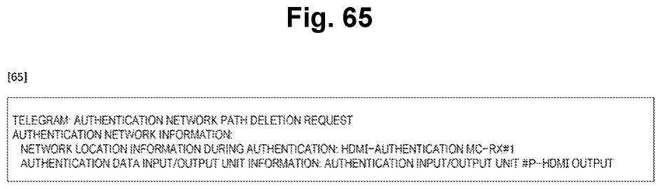

Upon completion of the location registration flows S13, the authentication infrastructure 20 transmits an authentication network path deletion request (see, for example, FIG. 65) to the network controller 40.

Step S14-2

The network controller 40 deletes the setting constructed as the authentication network path on the basis of the received authentication network path deletion request (see, for example, FIG. 65).

(3) Network Path Setting Flow

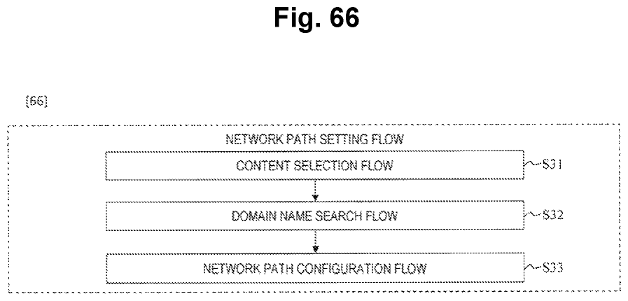

FIG. 66 is a diagram describing the present flow. The present flow includes a content selection flow S31, a domain name search flow S32, and a network path configuration flow S33.

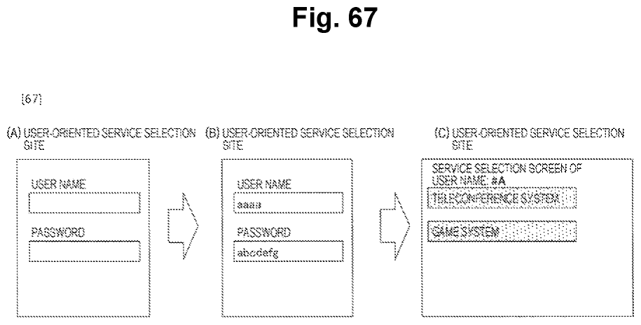

FIG. 67 is a diagram describing the content selection flow S31. The present diagram is an example of selecting a game system. The user A accesses the user-oriented service selection site 52 (FIG. 67(A)) using its own smartphone 11 in order to use the content. Next, the user A inputs its own ID and password in the user-oriented service selection site 52 (FIG. 67(B)). The user-oriented service selection site 52 refers to the user DB 34 (see, for example, FIG. 19), and in a case where the ID and the password match, the user-oriented service selection site 52 authorizes login of the user and displays a service selection screen for the user (FIG. 67(C)). The user A selects content desired to be used on the user-oriented service selection site 52 (FIG. 67(C)).

Next, the domain name search flow S32 will be described.

Step S32-1

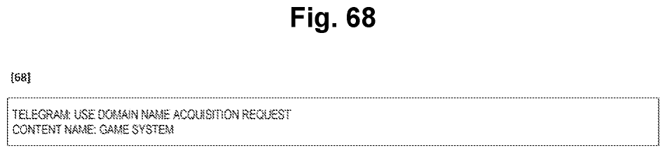

The user-oriented service selection site 52 transmits a use domain name acquisition request (see, for example, FIG. 68) to the content domain name DB 32 (see, for example, FIG. 14(A)) on the basis of the content name selected by the user A.

Step S32-2

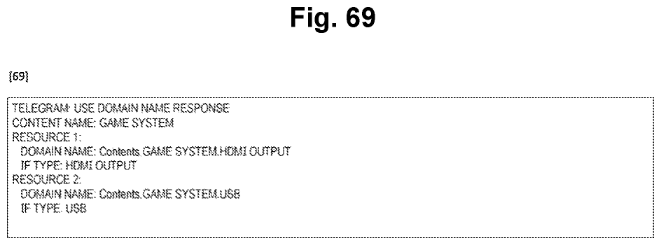

Upon receiving the use domain name request (see, for example, FIG. 68), the content domain name DB 32 transmits the domain name and the IF type of a resource associated with the content name as a use domain name response (see, for example, FIG. 69) to the user-oriented service selection site 52.

Step S32-3

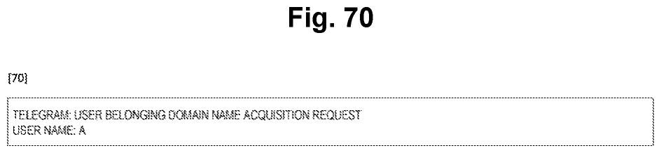

The user-oriented service selection site 52 transmits a user belonging domain name acquisition request (see, for example, FIG. 70) to the user belonging domain name DB 33 (see, for example, FIGS. 36, 50, and 63) on the basis of the user name.

Step S32-4

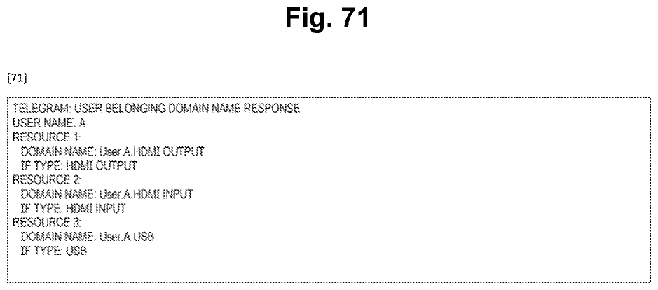

Upon receiving the user belonging domain name acquisition request (see, for example, FIG. 70), the user belonging domain name DB 33 transmits the domain name and the IF type of a resource associated with the user name as a user belonging domain name response (see, for example, FIG. 71) to the user-oriented service selection site 52.

Next, the network path configuration flow S33 will be described.

Step S33-1

The user-oriented service selection site 52 designs a set of domain names connected via the network on the basis of the domain name obtained in the domain name search flow S32. In this example, the following two apply:
“Contents.game system.HDMI output and User.A.HDMI output”
and
“Contents.game system.USB and User.A.USB”.

Step S33-2

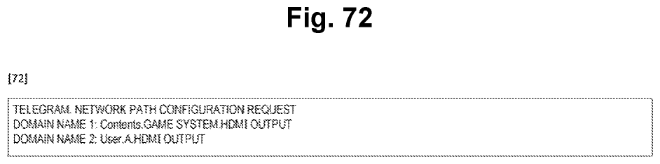

The user-oriented service selection site 52 transmits a network path configuration request (see, for example, FIG. 72) to the network controller 40 for the set of domain names.

Step S33-3

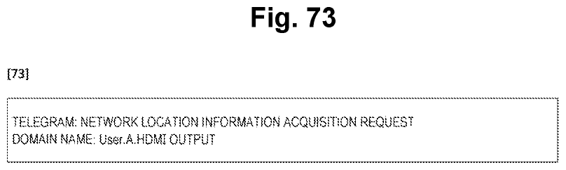

Upon receiving the network path configuration request (see, for example, FIG. 72), the network controller 40 transmits a network location information acquisition request (see, for example, FIG. 73) for each of the described domain names to the network location information DB 30 (see, for example, FIGS. 11, 33, 47, and 61).

Step S33-4

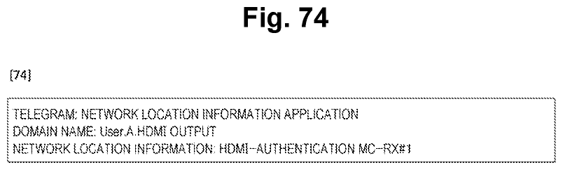

The network location information DB 30 transmits network location information obtained using the domain name as a network location information response (see, for example, FIG. 74).

Step S33-5

Using the network location information obtained in step S33-4, the network controller 40 designs a path for connecting the domain names with reference to the network configuration information DB 31 (see, for example, FIGS. 12 and 13), and sets an optical switch.

Step S33-6

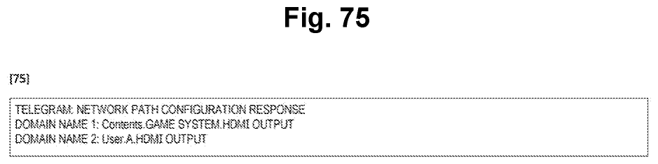

The network controller 40 transmits a network path configuration response (see, for example, FIG. 75) to the user-oriented service selection site 52. By performing the present operation, the monitor and the game controller to be used by the user A are connected to the game system 12.

Step S33-7

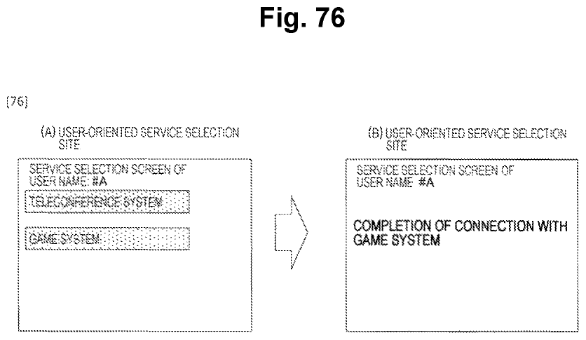

Upon receiving the network path configuration response (see, for example, FIG. 75) for the set of all the domain names designed in step S33-1, the user-oriented selection site notifies the user A of content connection completion via the smartphone (see, for example, FIG. 76(B)).

(4) Network Location Information Deletion Flow

Finally, a network location information deletion flow will be described.

Step S41-1

The user A removes the cable of the device (in this case, monitor) to be used from the authentication MC.

Step S41-2

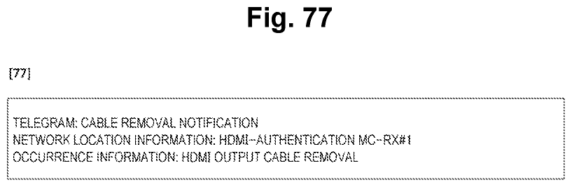

The authentication MC 10 transmits the fact that the cable has been removed and its own location information on the network together to the network controller 40 as a cable removal notification (see, for example, FIG. 77).

Step S41-3

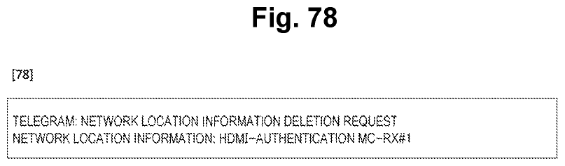

Upon receiving the cable removal notification (see, for example, FIG. 77), the network controller 40 transmits a network location information deletion request (see, for example, FIG. 78) to the network location information DB 30 using the network location information of the authentication MC in which the cable removal has occurred.

Step S41-4

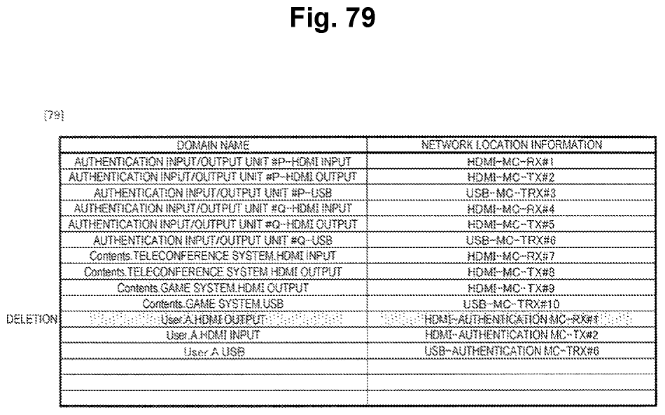

The network location information DB 30 deletes data associated with the network location information described in the network location information deletion request (see, for example, FIG. 78) (see, for example, FIG. 79).

Step S41-5

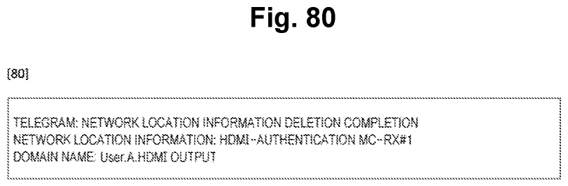

The network location information DB 30 adds a domain name and transmits network location information deletion completion (see, for example, FIG. 80) to the network controller 40.

Step S41-6

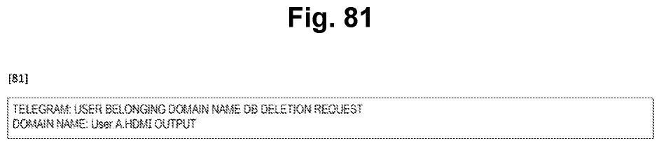

The network controller 40 transmits a user belonging domain name DB deletion request (see, for example, FIG. 81) to the user belonging domain name DB 33 by using the domain name described in the network location information deletion completion (see, for example, FIG. 80).

Step S41-7

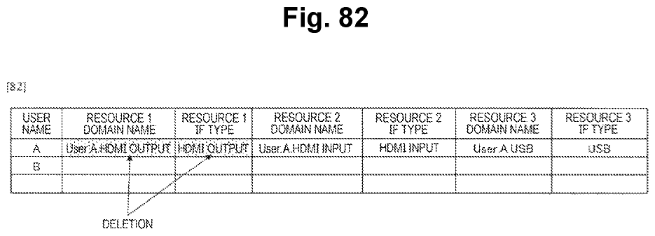

Upon receiving the user belonging domain name DB deletion request (see, for example, FIG. 81), the user belonging domain name DB 33 deletes data associated with the domain name (see, for example, FIG. 82).

Step S41-8

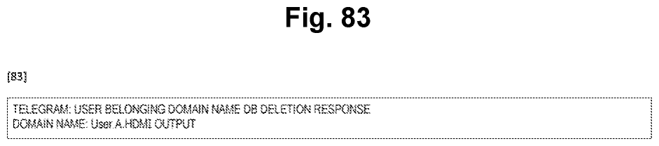

The user belonging domain name DB 33 transmits a user belonging domain name DB deletion response (see, for example, FIG. 83).

### Second Embodiment

The controller 40 can also be realized by a computer and a program, and the program can be recorded in a recording medium or provided through a network.

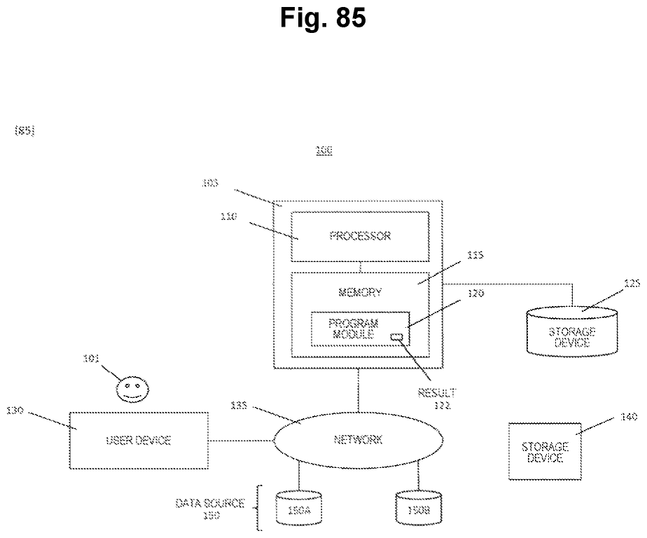

FIG. 85 illustrates a block diagram of a system 100. The system 100 includes a computer 105 connected to a network 135.

The network 135 is a data communication network. The network 135 may be a private network or a public network, and may include any or all of (a) a personal area network, for example, covering a room, (b) a local area network, for example, covering a building, (c) a campus area network, for example, covering a campus, (d) a metropolitan area network, for example, covering a city, (e) a wide area network, for example, covering an area connected across boundaries of cities, rural areas, or countries, and (f) the Internet. Communication is performed by an electronic signal and an optical signal via the network 135.

The computer 105 includes a processor 110 and a memory 115 connected to the processor 110. The computer 105 is represented herein as a standalone device, but is not limited thereto, and may be connected to other devices (not illustrated) in a distributed processing system.

The processor 110 is an electronic device including logic circuitry that responds to and executes instructions.

The memory 115 is a tangible computer readable storage medium in which a computer program is encoded. In this regard, the memory 115 stores data and instructions, i.e., program codes, that are readable and executable by the processor 110 to control the operation of the processor 110. The memory 115 can be implemented by a random access memory (RAM), a hard drive, a read-only memory (ROM), or a combination thereof. One of the components of the memory 115 is a program module 120.

The program module 120 includes instructions for controlling the processor 110 to perform processes described herein. In the present specification, it is described that operations are executed by the computer 105, a method, a process, or a sub-process thereof. However, the operations are actually executed by the processor 110.

The term “module” is used herein to refer to a functional operation that may be embodied either as a stand-alone component or as an integrated configuration of a plurality of sub-components. Therefore, the program module 120 can be implemented as a single module or as a plurality of modules that operate in cooperation with each other. Furthermore, although the program module 120 is described herein as being installed in the memory 115 and thus implemented in software, the program module 120 can be implemented in any of hardware (for example, an electronic circuit), firmware, software, or a combination thereof.

Although the program module 120 is shown as already loaded into the memory 115, the program module 120 may be configured to be located on a storage device 14₀ so as to be subsequently loaded into the memory 115. The storage device 14₀ is a tangible computer readable storage medium that stores the program module 120. Examples of the storage device 14₀ include a compact disk, a magnetic tape, a read-only memory, an optical storage medium, a hard drive or a memory unit including a plurality of parallel hard drives, and a universal serial bus (USB) flash drive. Alternatively, the storage device 14₀ may be a random access memory or another type of electronic storage device located in a remote storage system (not illustrated) and connected to the computer 105 via the network 135.

The system 100 further includes a data source 150A and a data source 150B collectively referred to herein as a data source 150, and communicatively connected to the network 135. In practice, the data source 150 may include any number of data sources, i.e., one or more data sources. The data source 150 may include unstructured data and may include social media.

The system 100 further includes a user device 130 operated by a user 101 and connected to the computer 105 via the network 135. The user device 130 includes an input device, such as a keyboard or a voice recognition subsystem, for enabling the user 101 to communicate information and command selections to the processor 110. The user device 130 further includes an output device such as a display device, a printer, or a speech synthesizer. A cursor control unit such as a mouse, a trackball, or a touch-sensitive screen allows the user 101 to manipulate a cursor on the display device to communicate further information and command selections to the processor 110.

The processor 110 outputs a result 122 of execution of the program module 120 to the user device 130. Alternatively, the processor 110 can provide the output to a storage device 125 such as a database or memory or to a remote device (not illustrated) via the network 135.

For example, a program for performing (2) the network location information DB dynamic configuration flow, (3) the network path setting flow, and (4) the network location information DB deletion flow described in the first embodiment may be used as the program module 120. The system 100 can be operated as the controller 40.

The term “comprise . . . ” or “comprising . . . ” specifies that the mentioned features, integers, steps, or components are present, but should be construed as not excluding the presence of one or more other features, integers, steps, or components, or groups thereof. The terms “a” and “an” are indefinite articles for an object and therefore do not exclude embodiments having a plurality of objects.

### Other Embodiments

Note that this invention is not limited to the above embodiments, and various modifications can be made without departing from the gist of this invention. In short, this invention is not limited to the high-order embodiments as they are, and can be embodied by modifying the components without departing from the gist of the present invention at the implementation stage.

In addition, various inventions can be made by appropriately combining a plurality of components disclosed in the above embodiments. For example, some components may be deleted from all the components indicated in the embodiments. Furthermore, components in different embodiments may be appropriately combined.

### [Gist of Invention]

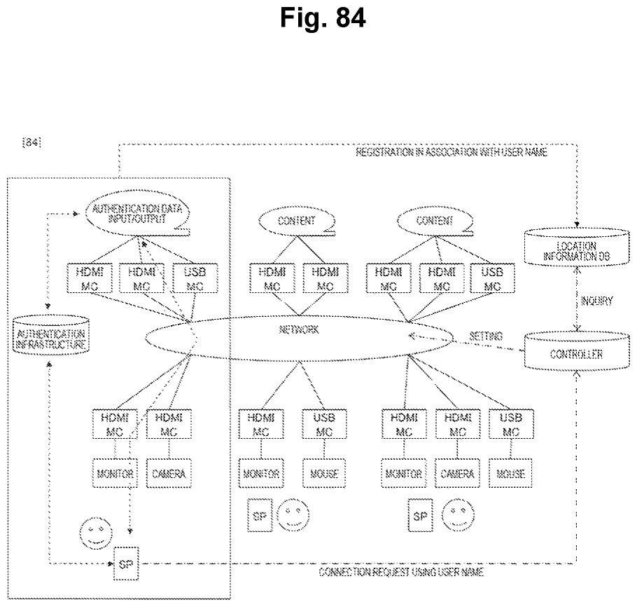

As illustrated in FIG. 84, the present invention includes:
(1) exchanging authentication data (QR code, sound, or the like) using a media signal of a device via a network, specifying the location of the device used by the user on the network on the network side, and recording the location of the device and the user name in association with each other in the location information DB, and
(2) when the user makes a connection request by using the user name, the controller inquires of the location information DB and specifies the location of the device used by the user on the network, and sets the network on the basis of the obtained location information.

### REFERENCE SIGNS LIST

10 Media converter
11 Smartphone
12 Game system
13 Teleconference system
14 Authentication data input/output unit
15 Device
20 Authentication infrastructure
30 Network location information DB
31 Network configuration information DB
32 Content domain name DB
33 User belonging domain name DB
34 User DB
40 Controller
50 Network
51 User-oriented authentication site
52 User-oriented service selection site
100 System
101 User
105 Computer
110 Processor
115 Memory
120 Program module
122 Result
125 Storage device
130 User device
135 Network
140 Storage device
150 Data source

1. A device interface direct access type network system in which a device not having a unique ID is connected via a media converter having a port having a unique ID and identifiable in a network, the network system comprising:
an authentication infrastructure that authenticates the device in an authentication operation of transmitting and receiving, via a user terminal, authentication data converted into a media signal between the user terminal of a user and the device by the media converter, and specifies the device used by the user from the media converter specified in the authentication operation; and
a database that registers location information in which location of the device specified in the authentication operation is associated with a user name of the user.

2. The network system according to claim 1, further comprising:
a controller that grasps the location of the device from the database on a basis of the user name of the user when the user makes a connection request to content in the network, and sets a path between the content and the device on a basis of the location.

3. The network system according to claim 1, wherein when the device is connected to the media converter, the authentication infrastructure performs the authentication operation, the database registers the location information for the device, and when the device is removed from the media converter, the database deletes the location information for the device.

4. A control method for a device interface direct access type network in which a device not having a unique ID is connected via a media converter having a port having a unique ID and identifiable in a network, the control method comprising:
authenticating the device in an authentication operation of transmitting and receiving, via a user terminal, authentication data converted into a media signal between the user terminal of a user and the device by the media converter, and specifying the device used by the user from the media converter specified in the authentication operation; and
registering location information in which location of the device specified in the authentication operation is associated with a user name of the user in a database.

5. The control method according to claim 4, further comprising:
grasping the location of the device from the database on a basis of the user name of the user when the user makes a connection request to content in the network, and setting a path between the content and the device on a basis of the location.

6. (canceled)

7. A controller included in a device interface direct access type network system in which a device not having a unique ID is connected via a media converter having a port having a unique ID and identifiable in a network, the controller comprising:
from a database that authenticates the device in an authentication operation of transmitting and receiving, via a user terminal, authentication data converted into a media signal between the user terminal of a user and the device by the media converter, and specifies the device used by the user from the media converter specified in the authentication operation, and in which location information in which location of the device specified in the authentication operation is associated with a user name of the user is registered,
grasping the location of the device on a basis of the user name of the user when the user makes a connection request to content in the network, and connecting the device to the content on a basis of the location.

8. A non-transitory computer-readable medium having computer-executable instructions that, upon execution of the instructions by a processor of a computer, cause the computer to function as as the controller according to claim 7.
